(19) United States
(12) Patent Application Publication
(10) Pub. No.: US 2004/0043096 A1
(43) Pub. Date: Mar. 4, 2004

(54) Dosing hopper for producing boards comprising oriented chips

(76) Inventors: Matthias Graf, Bretten (DE); Lutz Wolf, Darmstadt (DE); Guenter Natus, Muehltal (DE); Karl-Heinz Koehler, (US)

Correspondence Address: FASSE PATENT ATTORNEYS, P.A., P.O. BOX 726, HAMPDEN, ME, 04444-0726, US

(21) Appl. No.: 10/399,353

(22) PCT Filed: Oct. 12, 2001
(86) PCT No.: PCT/EP01/11830

(30) Foreign Application Priority Data
Oct. 12, 2000 (DE) 100 50 434.5

(51) Int. Cl. A23P 1/00

(52) U.S. Cl. 425/371

(57) ABSTRACT

The invention relates to a dosing hopper for producing panels with oriented chips (OSB, LSL), which is arranged above a spreading head and includes an apparatus for the pre-orientation (7) of the elongated flat wood strands (strands). This dosing hopper is characterized in that an oscillating conveyor or a parallel conveyor is provided below the pre-orientation apparatus (7), which conveyor distributes the pre-oriented wood strands in their pre-oriented position continuously over the entire hopper width.

The invention relates to a dosing hopper for producing panels with oriented chips according to the preamble of the Patent claim 1.

One generally understands OSB (oriented structural board) and LSL (laminated strand lumber) to refer to the technology of chip orienting for producing structural chip panels with higher strength values. The chips or wood strands (strands) used for this purpose in the ideal case comprise a length-width ratio of 10:1. In this context, the elongated wood strands usually have lengths of 80 to 200 mm, a width of 10 to 40 mm, and a thickness of 0.4 to 1 mm. In the production of such OSB or LSL panels, the wood strands, after the gluing, are often placed into nearly typical dosing hoppers for producing conventional chip panels, and are first spread out onto the forming belt in an oriented manner in the spreading head with special spreading devices.

Such a dosing hopper for producing conventional chip panels is known from the technical reference book by Deppe/Ernst, “Taschenbuch der Spanplattentechnik”, (Pocketbook of Chip Panel Technology), 3^{rd} Edition 1991, page 155. There, a horizontal dosing hopper is illustrated, in which the material flow is supplied or fed in at the top via a helical screw conveyor. Through a horizontal sluing or oscillating process, the helical screw conveyor distributes the chips or strands continuously over the entire hopper width. A floor belt is provided at the hopper floor, onto which the chips or wood strands are deposited, and which continuously conveys the entire chip layer with a small feed advance to a discharge opening. In order that the most uniform possible quantity is conveyed out into the spreading head, a reverse or return combing apparatus is provided at the top in the hopper, by which a constant filling height is achieved by return striking or evening rakes. Discharge rolls are arranged above the discharge opening over the entire bulk bed height. These discharge rolls mill or till off the chips or strands supplied by the floor belt and convey the chips or strands into the discharge opening to the spreading head. In the elongated wood strands for producing LSL or OSB panels, which are fed into the dosing hopper in a disordered manner, areas or regions with parallel layered wood strands and areas or regions with wood strands formed into tangles develop in the filling height, whereby these areas or regions comprise quite different material densities. These different layering patterns comprise very different discharge characteristics, since the wood layers that are locked together into a tangle require a higher pressing pressure against the discharge rolls than the parallel layered wood layers. Thereby, due to the elasticity of the bulk fill in the use of elongated wood strands, there arises partially a pulsating discharge, which leads to a non-uniform spreading head supply feed and which can disadvantageously influence the spreading onto the forming melt.

A spreading head for producing OSB panels with a filling space or chamber acting as a dosing hopper, into which the wood strands or “strands” are fed in a pre-oriented manner by roll pairs, is already known from the technical reference book of Deppe/Ernst, page 256. The pre-oriented longitudinally extending or elongated wood strands are then conveyed out of the filling space by an overshot belt arranged inclined at an upward angle. Thereby, a constant width distribution is apparently achieved by two equalizing rolls, which comb back the non-uniform height distribution on the overshot belt to a constant conveying height. However, thereby the wood strands are thrown back into the filling space in a disordered manner, so that a large part or portion of the elongated wood strands thereafter are only dischargeable in a disordered manner. Thereby, areas or regions with parallel layered layers or disordered tangles can also arise over the width of the hopper, which at least lead to a non-uniform discharge over the width. Even if a weighing scale with a following roll pair is provided after the overshot belt for pre-orienting the wood chips, and a further conveyor belt is provided for the discharge, thereby a uniform crosswise distribution still cannot be achieved again subsequently or retrospectively.

It is thus the underlying object of the invention, to provide a dosing hopper for producing OSB or LSL panels, from which the most uniform possible discharge quantities over the entire width are dischargeable into spreading head.

This object is achieved by the invention recited in the Patent claim 1. Further developments and advantageous example embodiments are recited in the dependent claims.

The invention has the advantage that a uniform supply or reserve quantity is formed over the entire hopper width, through the pre-oriented crosswise distribution in the dosing hopper, whereby this uniform supply or reserve quantity is available for discharge in the spreading head, whereby a uniform spreading of the wood strands onto the forming belt is made possible. Simultaneously, through the layer-wise depositing of the oriented wood strands, special break-up or separating and equalizing means are no longer necessary for the discharge, so that a uniform, gentle and protective material discharge into the spreading head is achievable in an advantageous manner with simple conveying means.

The invention further has the advantage that the proportion of fines in the hopper is barely increased due to the layered depositing of the elongated wood strands in the dosing hopper and their unhindered further transport, whereby OSB or LSL panels having maximum strength values are producible.

The invention is described in further detail in connection with an example embodiment, which is shown in the drawing. It is shown by:

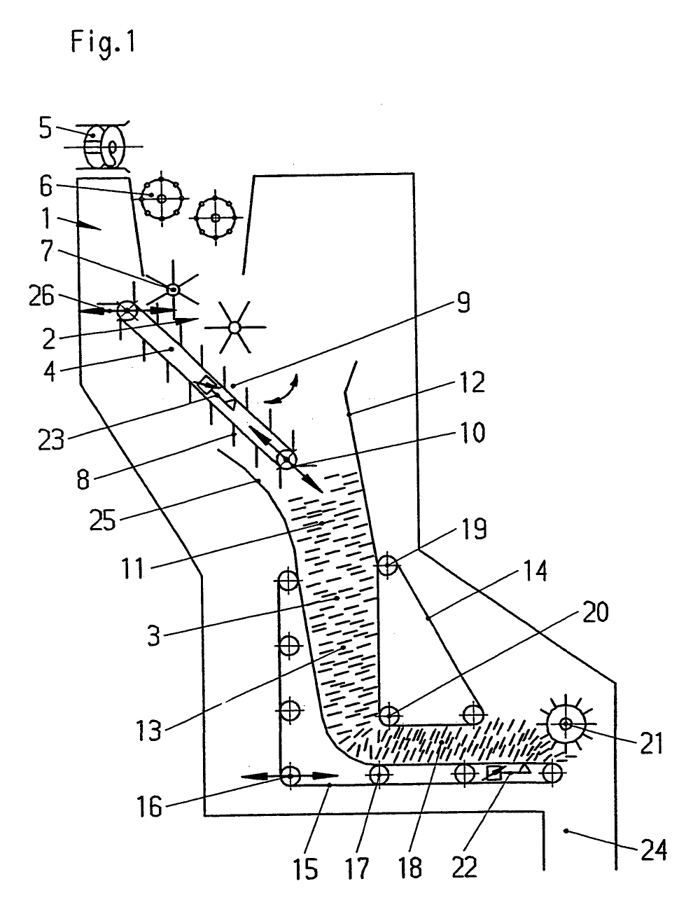

FIG. 1: a vertical dosing hopper with a pre-orienting device and an oscillating conveyor, and

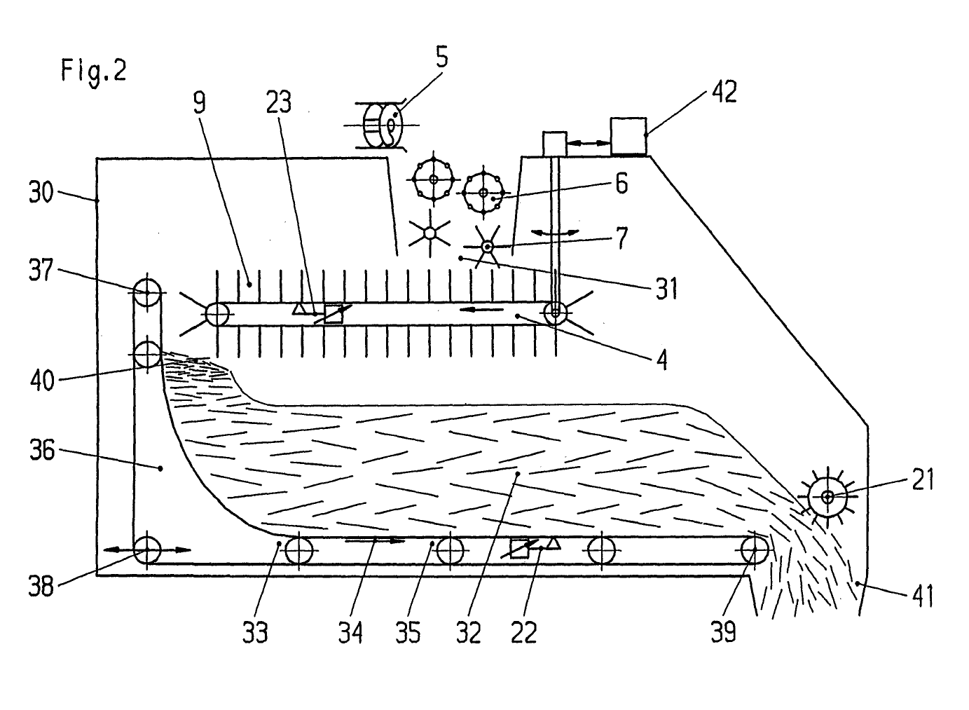

FIG. 2: a horizontal dosing hopper with a pre-orienting device and an oscillating conveyor.

In FIG. 1 of the drawing, a vertical dosing hopper 1 with orienting rolls 7 as an orienting device and an oscillating conveyor 4 with depositing pockets 9 is schematically illustrated. The hopper distributes the oriented elongated flat wood strands (strands) in an oriented manner in a vertical filling chamber or space 3 uniformly over the hopper width.

In the production of OSB or LSL panels, glued elongated flat wood chips or strands (strands) with a length of 80 to 200 mm, a width of 10 to 40 mm, and a thickness of 0.4 to 1 mm are processed to form wood material panels. These wood strands are supplied via a helical screw conveyor 5 from a gluing mixer to the dosing hopper 1. The wood strands thereby come continuously out of the trough of the helical screw conveyor 5 in an unordered manner, and are to be spread onto a forming belt to form an oriented fleece, without damage to the extent possible. Namely, due to the damage of the elongated wood strands, the bending strength would be impaired or the thereby arising increased proportion of fines would have to be additionally separated. For this reason, the invention suggests a dosing hopper 1 with an oriented in-feed, so that the elongated wood strands are intermediately stored in ordered layers without any significant density fluctuations, to the extent possible, in the dosing hopper 1, and therefore are easily separable and uniformly dischargeable. Therefore, the elongated wood strands are deposited out of a trough of a helical screw conveyor 5 above the dosing hopper 1, first onto two or more break-up rolls 6, which are to separate or break-up any possible occurring clumps or entanglements. For this purpose, preferably coarse-meshed cage rolls or spike rolls with few elastic spikes are provided, through which the loose wood strands can fall through nearly without any braking and free of damage.

At least two orienting rolls 7 are provided below the break-up rolls 6. The elongated wood strands glide into the slits of the orienting rolls 7 perpendicularly to the conveying direction. In this context, the orienting rolls 7 consist of a continuous through-going drive shaft, around which crosswise plates are provided and arranged in a star-like manner. Thereby, the spacing distances between the crosswise plates represent tapering slits, which are only so wide that the strands can glide thereinto only in a crosswise orientation. The orienting rolls 7 could, however, also be arranged in the conveying direction, so that the elongated wood strands would be oriented lengthwise. For the lengthwise orientation, however, disk rolls are also utilizable through the slits of which the elongated wood strands would be directed in the lengthwise direction.

An oscillating conveyor belt 4 is arranged as an oscillating conveyor below the orienting rolls 7. The pre-oriented wood strands are deposited from the orienting rolls 7 onto the oscillating conveyor belt 4. Thereby, the conveyor belt is provided with crosswise webs 8 or crosswise plates, which form conveyor pockets 9 between the individual webs 8. Thereby, the spacing distances of the crosswise webs 8 or crosswise plates are dimensioned so that the wood strands can only be laid into the conveyor pockets 9 in their crosswise orientation, so that the crosswise orientation is maintained on the oscillating conveyor belt 4. With a lengthwise orientation, the conveyor belt could, however, also be provided with lengthwise webs, which take up the wood strands only in the lengthwise direction.

On its feed or take-up area, the oscillating conveyor belt 4 is supported in a manner so as to be swingable or oscillatable crosswise and horizontally, and the oscillating conveyor belt 4 is tilted downward at an angle relative to the horizontal in the conveying direction. Thereby, the output or discharge end of the oscillating conveyor belt 4 is arranged to extend or plunge into the vertical filling space 3. The oscillating conveyor belt 4 is connected with a known oscillating or swinging drive, which is not shown, and which continuously swings or oscillates the relatively narrow conveyor belt 4 of maximally 1 m width back and forth over the entire hopper width. Thereby the elongated wood strands are deposited or laid down layer-wise over the entire hopper width. In this context, the hopper width corresponds approximately to the spreading width, which generally amounts to 2 to 4 m.

The crosswise distribution of the elongated wood strands could also be achieved by a parallel conveyor, which is continuously pushed or slidingly moved back and forth over the hopper width parallel to the conveying direction. This parallel conveyor could also be embodied as a belt conveyor, which would be supported to be pushable or slidably displaceable perpendicularly to the conveying direction at its material in-feed side and its material delivery side. Two linear drives arranged in parallel, such as spindle drives for example, could be connected with these bearing support points. The drives push or slide the conveyor back and forth continuously over the hopper width. While this would be mechanically more complicated, this would leave the discharge angle of the elongated wood strands unchanged over the course of the hopper width.

For the continuous crosswise distribution of the wood strands in the vertical filling space 3, a belt weighing scale 23 is provided in the oscillating conveyor belt 4, and the conveying rate of the conveyed wood strands is determined by the belt weighing scale 23. Thereby, the crosswise oriented wood strands are layable or depositable in a weight-dosed manner over the entire width of the dosing hopper 1 or the vertical filling space 3. In this context it is provided to lay down or deposit always the same weight quantity of wood strands over the entire hopper width, so that the vertical filling space 3 is uniformly filled. Therefore, a constant conveying rate (t/h) is prescribed, in connection with which, by a deviation from the rated or nominal weight, the belt speed is re-adjustable or regulatable in a following manner, whereby the swinging or oscillating speed remains constant. A prescribed conveying rate (t/h) could, however, also be regulated by the swinging or oscillating speed. Since the oscillating conveyor belt 4 is sloped or inclined downwardly in the conveying direction, the downward inclination or slope of the conveyor belt 4 is detected by an inclination sensor or taken into account in a computerized manner with a constant inclination angle, in connection with the weight-dosed discharge. For this purpose, an evaluating device, not shown, is provided, by means of which both the belt loading as well as the belt speed is detected or acquired. In the event of a deviation from the prescribed conveying rate or from the rated or nominal weight, the belt speed of the conveyor belt 4 or the oscillating speed is correspondingly readjusted or regulated in a following manner.

While laying down or depositing the crosswise or lengthwise oriented wood strands in the vertical filling space 3, in order that the orientation is not lost, the spacing between the discharge location of the conveyor belt 4 from the depositing location in the vertical filling space 3 should not exceed a certain height spacing distance. For this reason it is provided that the oscillating conveyor belt 4 is adjustable in the conveying direction 10 so that it can reach or plunge more or less deeply into the vertical filling space 3. This can be carried out in a simple manner with a stroke or lift cylinder or a spindle drive. For this purpose, additional fill level sensors (not shown) are provided, which maintain a constant spacing distance from the wood strand surface in the vertical filling space 3 by means of a program controlled evaluating device.

In its filling area, the vertical filling space 3 consists of an upper filling shaft or chute 11, which consists of approximately parallel arranged rigid sidewalls 12, 25, which extend crosswise over the entire hopper width. These are secured at the end face on the hopper outer wall and form a rigidly surrounded or enclosed filling space 11. A vertical conveying shaft or chute 13 is arranged below this upper filling shaft 11. The conveying shaft 13 essentially consists of two vertically arranged discharge conveyor belts 14, 15, which undergo a horizontal deflection 16, 20 in their lower area or region. These belts 14, 15 extend over the entire hopper width, and, together with the end face side outer walls of the dosing hopper 1, form an enclosed conveying shaft 13, which continuously conveys the hopper contents to a discharge opening 24. The conveying shaft 13 could, however, also be formed of only one discharge conveyor belt 14 and a rigid sidewall arranged lying opposite thereto.

Regarding the two discharge belts 14, 15, these are respectively an endless belt, that is arranged between three deflection rolls 16, 19, 20, which are arranged approximately like the end points a right-angled triangle. Thereby, the two conveyor belts 14, 15 respectively adjoin the bottom point of the side walls 12, 25 of the upper filling shaft 11, and thereby form its extension. Thereby, the two discharge belts 14, 15 are arranged so that they are provided with differing roll spacings. Thereby, the roll spacings are provided so that both a vertical conveying shaft 13 as well as a horizontal conveying shaft 18 are formed between the two conveyor belts 14, 15. In these deflected shafts 13, 18, the oriented wood strands are conveyed to a discharge opening 24.

In that context, the vertical conveying shaft 13 is embodied as a converging or squeezing or pinching path section, in that the shaft can be tapered downwardly on at least one inner side surface. This is achieved in that the lower discharge belt 15 lies only loosely on its support rolls 17, and the shaft width is adjustable with a horizontally adjustable tension roll 16. Due to the narrowing of the shaft width, the layers of the oriented wood strands are laterally squeezed in or pinched, so that these are carried along in the conveying direction by the motion of the discharge belts 14, 15. Thereby, it is simultaneously achieved that the individual layers in the lower region of the vertical conveying shaft 13 are not significantly compacted or compressed due to the filling height, so that an easily separatable bulk fill is maintained in the vertical shaft 13.

In the start-up operation, the vertical conveying shaft 13 is closable in the deflection area with the aid of the tension roll 16, so far that both discharge belts 14, 15 lie lightly against or in contact on one another with their inner walls. This prevents the occurrence that the wood strands to be newly filled-in can slide through to the discharge opening 24. Simultaneously, the vertical shaft 13 is reduced in size so far that the discharge height is only so large that an oriented laying-down or depositing remains assured in the vertical conveying shaft 13. While filling in the wood strands, the fill height is detected by the fill level sensors, and is provided to the evaluating device. This controls the following guidance or motion of the oscillating conveyor belt 4 in the conveying direction 10, so that the spacing distance to the fill level plane remains the same so long until a prescribed filling height is achieved. As soon as the converging, squeezing or pinching path section 13 is filled to the intended height, the belt tension is loosened by the adjustable tension roll 16, so much until a prescribed pinching effect is achieved. For this purpose, the lower shaft width can be enlarged so far that it corresponds to the shaft width of the upper filling shaft 11.

After filling up the converging, squeezing or pinching path section 13, the material conveying rate that is to be filled-in is increased so much until an intended total fill height is reached in the vertical filling space 3. This nominal or rated fill level height is detected by the fill level sensors, whereby upon reaching the nominal or rated fill level height, the in-feed conveying rate is regulated by the evaluating device so that the hopper 1 is always filled up to the nominal or rated fill level height. The fill level sensors can be arranged distributed on the end face side of the hopper so that they also detect the fill level height perpendicularly to the hopper width. For this purpose, the oscillating conveyor belt 4 can also be arranged to be slidably displaceable horizontally and perpendicularly 26 relative to the hopper width, and thus lengthwise relative to the forming belt, so that a constant filling height is also maintainable perpendicularly to the hopper width.

In the lower region of the converging, squeezing or pinching path section 13 or of the vertical conveying shaft 13, a deflection of the vertical discharge flow into a horizontal discharge flow takes place through the lower tension roll 16 of the lower discharge belt 15 and the upper tension roll 20 of the upper discharge belt 14. Thereby, a sliding-through of the vertical material flow to the discharge opening during the discharge operation is advantageously prevented. Simultaneously, a loosening of the compaction or compression effect is also achieved, so that a gentle protective uniform discharge into the spreading head is made possible. The vertical filling space 3 could, however, also be formed by two parallel oppositely arranged conveyor belts, that are directed toward two horizontal conveyor belts, which then form the horizontal filling shaft. A bucket wheel sluice or chute could, however, also be provided below the vertical filling space 13, through which the oriented wood strands are discharged into the spreading head according to the manner of the orienting rolls.

The horizontal discharge flow in the horizontal conveying shaft 18 in this regard represents a squeeze-free or pinch-free filling path section, which forms a horizontal supply reserve. This horizontal filling path section 18 predominantly serves for bringing about a uniform discharge behavior. This is predominantly achieved in that a loosening of a vertical layering is carried out by the deflection, so that a uniformly dischargeable material flow becomes adjusted or formed in the horizontal shaft 18.

The two discharge belts 14, 15 are regulatable in their belt speed. In this context, the belt speed of both discharge belts is regulated so that they ensure a constant-remaining discharge speed in the shafts 13, 18, so that the pre-orientation is not changed, and so that a material turning-over or tilling does not arise in the shafts 13, 18, to the extent possible. Preferably, a belt weighing scale 22 is still further provided at the belt end of the horizontal conveying shaft 18, by means of which belt weighing scale 22 the discharge quantity is regulatable via the discharge belt speed. Additionally, still further, a striking or strike-off roll 21 is provided at the belt end of the horizontal conveying shaft 18, which striking roll 21 combs off the oriented wood strands in a gentle protective manner into the discharge opening 24 to the spreading chamber. Thereby, the vertical hopper 1 ensures a gentle protective supplying or feeding and uniform weight-dosed discharge of the elongated wood strands, so that these can develop their maximum strength in the OSB or LSL panels that are to be spread-out, and are not impaired by the arising proportion of fines. The feed device 2 arranged in the vertical hopper 1 could, however, also be provided in a separate device component above the hopper housing, if this is possible and advantageously achievable for structural reasons.

In FIG. 2 of the drawing, a horizontal hopper 30 with orienting rolls 7 as an orienting device and an oscillating conveyor 4 with depositing pockets 9 is schematically illustrated. The hopper deposits the flat elongated wood strands (strands) in an oriented manner onto a horizontal filling path section 32 uniformly over the hopper width.

The horizontal hopper 30 essentially consists of a feed device 31 and a horizontal filling path section 32, which is formed from a floor belt 33. A helical screw conveyor 5 is arranged above the feed device 31, and brings up or supplies the glued elongated wood strands (strands) from a gluing mixer. This helical screw conveyor 5 corresponds to the helical screw conveyor according to FIG. 1 of the drawing, whereby the same reference numbers have also been used for the similar components in FIG. 2 of the drawing.

The feed device 31 essentially consists of the orienting rolls 7 and an oscillating conveyor 4. Thereby, the elongated wood strands, for producing OSB or LSL panels, are first deposited onto at least two break-up rolls 6 and the orienting rolls 7 arranged thereunder. The oscillating conveyor 4, which is formed of a conveyor belt provided with pockets 9, is arranged below the orienting rolls 7. Instead of an oscillating conveyor 4, a parallel conveyor could also be provided.

The horizontal hopper 30 extends across the entire width of the spreading head, which can amount to up to 4 m. The oscillating conveyor 4, in comparison, has only a width of maximally 1 m, and is continuously oscillated or pivoted horizontally back and forth over the entire width of the dosing hopper 30, and thereby distributes the supplied wood strands uniformly over the width of the hopper 30. In this context, the oscillating speed is a multiple of the discharge speed, so that the oriented wood strands are laid down or deposited layer-wise on top of one another. The oscillating conveyor 4 is arranged horizontally over the filling path section 32 and conveys the oriented wood chips to the filling section opposite to the discharge direction 34. The oscillating conveyor 4 can also be sloped or inclined relative to the horizontal, so that the oriented wood strands can be laid down or deposited in an oriented manner in the bottom area or region of the filling path section 32 during the start-up operation. For that purpose, fill level sensors (not shown), which detect the fill height on the side surfaces perpendicular to the hopper width, are provided. In a program or processor controlled evaluating device (not shown), the slope or inclination of the oscillating conveyor 4 can be readjusted or regulated in a following manner by means of the fill level sensors and a prescribed spacing distance to the fill height. In this context, the oscillating conveyor 4 is only followingly readjusted or regulated so far until a prescribed nominal or rated fill level height is reached in the hopper 30. After reaching this prescribed nominal or rated fill level height, the floor belt 33 can be controlled so that the fill layer is conveyed to the discharge opening 41. However, the oscillating conveyor 4 in this context can also be arranged so that it is supported to be adjustable in the conveying direction 34. For this purpose, a spindle drive 42 is provided, by which the oscillating conveyor 4 is lengthwise slidably displaceable in conveying direction 34. Thereby, with the aid of fill level sensors arranged in conveying direction 34, a constant filling height in conveying direction 34 could already be adjustably settable by the lengthwise adjusting of the conveyor 4, and possible refilling interruptions could be filled up.

A belt weighing scale 24, which detects the weight quantity of the conveyed wood strands, is provided near the discharge end in the oscillating conveyor belt 4. In this context, with a constant oscillating speed, the belt speed is regulated so that the wood strands are distributed over the width of the dosing hopper 30 with an always constant conveying rate (t/h), so that, with a prescribable discharge quantity, a uniform filling quantity on the filling path section 32 is achieved over the entire floor belt width. For regulating the conveying rate in this context, a program or processor controlled evaluating device (not shown) is provided, as they are used in known dosing belt weighing scales.

The floor belt 33 essentially consists of an elongated horizontal part 35 and a shortened vertical part 36, that are formed by three deflection rolls 37, 38, 39 arranged like a triangle. The floor belt 33 is tensionable to a variable degree by the lower horizontally adjustable tension and deflection roll 38. Thereby, the belt can be shortened to such a degree in the start-up operation, so that the loosely contacting discharge belt 33 in the depositing region 40 of the wood strands is inclined or positioned to a slope angle so far so that the wood strands are depositable in a substantially oriented manner onto the discharge belt 33 in the depositing region 40. Thereby, an ordered depositing possibility arises in the horizontal hopper 30 already during the start-up operation, so that a uniform filling height with oriented wood chips builds up, which is then conveyed by means of a prescribed discharge speed to the discharge opening 41.

A belt weighing scale 22 is provided at the discharge end in the floor belt 33, with the aid of which an intended discharge quantity is regulatable by the belt speed of the floor belt. Thereby, through the oriented and therewith uniform feeding of the elongated wood strands, a uniform discharge into the spreading head is possible over the entire hopper width, without an additional volume oriented crosswise distribution in the dosing hopper 30 being necessary. The in-feed conveying rate of the oscillating conveyor 4 or of the parallel doser can also be regulated by the discharge belt weighing scale 22 by means of an evaluating device.

1. Dosing hopper for producing panels with oriented chips, which is arranged above a spreading head and includes an apparatus for pre-orienting the elongated flat wood strands (strands), characterized in that an oscillating conveyor (4) or a parallel conveyor is provided below the pre-orienting apparatus (7), and distributes the pre-oriented wood strands in their pre-oriented position continuously over the hopper width.

2. Dosing hopper according to claim 1, characterized in that the pre-orienting apparatus (2) consists of at least one orienting roll (7) or at least one disk roll, which is embodied and arranged in such a manner so that the supplied wood strands orient themselves lengthwise or crosswise oriented relative to the discharge direction (34).

3. Dosing hopper according to claim 1 or claim 2, characterized in that the oscillating conveyor or the parallel conveyor are embodied as a belt conveyor (4), on the conveyor belt of which, lengthwise or crosswise pockets (9) for receiving crosswise or lengthwise oriented wood strands are provided.

4. Dosing hopper according to one of the preceding claims, characterized in that the oscillating conveyor (4) is arranged swingable or sluable horizontally and over the hopper width, and is movable back and forth continuously over the hopper width by a drive.

5. Dosing hopper according to one of the preceding claims, characterized in that the parallel conveyor is arranged slidable horizontally and parallel to the conveying direction (34), and is slidable back and forth continuously over the hopper width by one or more drives.

6. Dosing hopper according to one of the preceding claims, characterized in that the oscillating conveyor (4) or the parallel conveyor is arranged horizontally or sloping tilted downwardly in the conveying direction, and is adjustable in its slope and/or in the conveying direction (34).

7. Dosing hopper according to one of the preceding claims, characterized in that the pre-orienting apparatus (7) and/or the oscillating conveyor (4) is arranged in the hopper housing or above the housing.

8. Dosing hopper according to one of the preceding claims, characterized in that the oscillating conveyor (4) or the parallel conveyor is connected with a weighing apparatus (23), which determines the weight of the discharged wood strands.

9. Dosing hopper according to one of the preceding claims, characterized in that the oscillating conveyor or the parallel conveyor is embodied as a dosing belt weighing scale, which consists of a conveyor belt with an integrated weighing apparatus, and which determines the conveying rate during a continuous oscillating process and compares the conveying rate with a prescribed conveying rate (t/h), and upon a deviation, regulates the belt speed or the oscillating speed so that a constant weight-wise material quantity with a pre-oriented orientation is always discharged over the entire hopper width.

10. Dosing hopper according to one of the preceding claims, characterized in that the hopper is embodied as a vertical hopper (1), a horizontal hopper (30), or as a combination of a vertical and horizontal hopper.

11. Dosing hopper according to one of the preceding claims, characterized in that the vertical hopper includes a vertical filling space (3), which is arranged below the conveyor (4) and includes at least one vertical conveying shaft (13), which is formed of at least one or two vertical conveyor belts (14, 15).

12. Dosing hopper according to one of the preceding claims, characterized in that the vertical hopper, at the outlet of its vertical filling space (3), includes a horizontal conveying shaft (18) or a bucket wheel sluice.

13. Dosing hopper according to one of the claims 1 to 10, characterized in that the hopper is embodied as a horizontal hopper (30), which includes a horizontal filling path section (32), which is formed by the floor belt (33) and is arranged below the doser (4).

14. Dosing hopper according to claim 13, characterized in that the floor belt (33) consists of a horizontal part (35) and a vertical part (36), which is formed by at least three deflection rolls (37, 38, 39), which are arranged like the corner points of a triangle.

15. Dosing hopper according to one of the preceding claims, characterized in that a discharge belt weighing scale (22) is provided on the horizontal conveying shaft (18) or on the floor belt (33), and with the aid of which the discharge conveying rate and/or the feed conveying rate is regulatable.

16. Dosing hopper according to one of the preceding claims, characterized in that fill level sensors are provided on the vertical filling space (3) or on the horizontal filling path section (32), which fill level sensors detect the respective fill level heights in vertical and/or horizontal direction.

17. Dosing hopper according to claim 16, characterized in that the fill level sensors are connected with an evaluating device, which is embodied so that, with the aid of the fill level signals, the conveyor (4) can be readjusted or regulated horizontally along or inclined relative to the horizontal in a manner following the respective fill level height.

18. Dosing hopper according to claim 16 and 17, characterized in that the evaluating device is connected with the dosing belt weighing scale (4) and embodied so that the feed conveying rate is regulatable with the aid of the fill level signals.
